(19) United States
(12) Patent Application Publication
(10) Pub. No.: US 2003/0222374 A1
(43) Pub. Date: Dec. 4, 2003

(54) Process for manufacturing a nonwoven fabric of synthetic fiber with scented matter

(76) Inventors: Massimiliano Castellari, Gainesville, GA (US); Silvia Ferranti, Settala (IT)

Correspondence Address: Bryan W. Bockhop, Arnall Golden Gregory LLP, 1201 West Peachtree Street, Atlanta, GA, 30309-3450, US

(21) Appl. No.: 10/247,169

(22) Filed: Sep. 19, 2002

(30) Foreign Application Priority Data
May 28, 2002 (IT) MI2002A001155

(51) Int. Cl. B29C 47/60

(52) U.S. Cl. 264/210.8; 264/211.22; 264/324

(57) ABSTRACT

The present invention refers to a process for manufacturing a nonwoven fabric of synthetic fiber with scented matter. The process consists of producing a molten mass of thermoplastic resin, inserting a base mixture into the mass containing microcapsules of a scented substance, extruding the mass and drawing the extruded filaments, and using the extruded threads to create a web of nonwoven fabric.

### FIELD OF THE INVENTION

The present invention relates to a process for manufacturing a nonwoven fabric of synthetic fiber with scented matter.

### CROSS REFERENCE TO RELATED APPLICATION

This application claims foreign priority under 35 U.S.C §119(a) to an Italian application, registration number M12002A001155, registered on May 28, 2002.

### BACKGROUND OF THE INVENTION

As is known, to make it possible for an extruded, nonwoven, thermoplastic fiber to exude a scent, current processes involve applying a finish containing the scented material, attaching it to the nonwoven fabric web, or otherwise coextruding the scented product while the web is being shaped.

The finishing techniques currently used lead to significant loss of scent due to the scent's incompatibility with the plastic material. This leads to a continual reduction in the time the scent remains on the web owing to its high rate of evaporation.

In the instance of coextrusion with the supporting plastic material, the quantitative reduction in absorption during extrusion limits the amount of time that the scent remains. Furthermore, the scented substance could lead to breakage of the thread owing to its high vapor pressure

Owing to the above difficulties, methods currently used to manufacture a scented fiber web have proven to be highly unsatisfactory; moreover, the scents that can be used for this type of application are limited with regard to their olfactory quality, due to problems with the support material and the negative effects of the extrusion temperature that must be employed.

### SUMMARY OF THE INVENTION

The task relating to the present invention is to solve the aforesaid problem by means of a process for manufacturing nonwoven fabric of synthetic fiber using scented matter so as to produce a nonwoven fabric in the form of a web that contains a scented substance capable of giving off a scent for a long time.

With regard to the aforesaid task, one particular goal of the invention is to create a process whereby the introduction of the scented substance does not weaken the mechanical characteristics of the web, and, moreover, optimizes these web characteristics. Thus webs of nonwoven fabric can be produced that can be applied to many uses, for example absorbent diapers, diapers for the incontinent, curtains, household products and similar items.

Another goal of the present invention is to create a process involving applications previously not possible, with a wide range of useable scent treatments.

Last but not least among the goals of the present invention is to create a readily achievable process using components and materials commonly found on the market, which is also competitive from a purely financial standpoint.

The above task, in addition to the goals referred to and others below, is accomplished through a process for manufacturing a nonwoven fabric of synthetic fiber with scented matter, according to the invention, characterized by producing a molten mass of thermoplastic resin, introducing a base mixture containing microcapsules of a scented substance into the aforesaid mass, extruding the mass, drawing the extruded threads, and producing by means of these extruded threads a web of nonwoven fabric.

Other characteristics and advantages can be further seen in the description of one preferred, albeit not exclusive, way to carry out a process for manufacturing a nonwoven fabric of synthetic fiber with scented matter, as explained in the Description section.

### DETAIL DESCRIPTION OF THE INVENTION

According to the invention, the process for manufacturing a nonwoven fabric made of synthetic fiber with scented matter is based on a molten mass of thermoplastic resin that is preferably polypropylene, polyethylene or polyester.

A special characteristic of the invention is that a scented or perfumed substance, comprised of a base mixture containing microcapsules or microballs of the desired scented substance, is introduced into the molten mass, for example a substance comprised of ACCUREL FRAGRANCE (Akzo Nobel).

The base mixture is stirred into a compound that uses the same thermoplastic resin as for the web, and preferably, as experimentally demonstrated, the base mixture should contain around 10-70% of the weight of molten mass with the scent microcapsules.

The scent preferably has a high boiling point in order to resist normal operating temperatures during extrusion without changing or deteriorating.

The base mixture, as previously described, is introduced during extrusion at a percentage ranging from 0.2 to 5% by weight with respect to the total weight of the molten mass.

The base mixture is obtained using the desired fragrance that has been incorporated into microballs or microcapsules measuring less than one micron and which are mixed throughout the thermoplastic used.

During extrusion and subsequent operations, most of the microballs remain intact in the threads of the fabric, as a result of which the scented substance releases its fragrance over a long period of time.

Because the fragrance is contained in microcapsules, its thermal deterioration is slowed down.

The extrusion temperature of the thermoplastic resins should range from 230° C. to 270° C., thus obtaining a total amalgam of both substances, with a spun fabric almost totally free of broken filaments.

It is advisable to use Atofina Finapro 10099 polypropylene, or its equivalents from Basell and Amoco, with a melting index ranging from 20-40 (g/10 min. 230° C. 2.16 kg).

The resin mass into which the scented substance microcapsules have been introduced is extruded and the continuously extruded threads are drawn, preferably, by means of compressed air flow to obtain a thread diameter ranging from 1 to 4 dtex.

Next the extruded filaments are spread in an overlapping pattern over a conveyor belt, producing a nonwoven fabric web that is compressed into a single piece by two heated rollers, one of which is embossed.

Compression temperature remains at 120° C. to 180° C.

The nonwoven fabric web thus obtained is then wound onto rolls in preparation for the next steps.

In addition to the above, it should be pointed out that the diameter of extruded filaments should be no less than 0.5 dtex; smaller diameters could result in frequent filaments breakage owing to the excessive size of the microcapsules in contrast to the thread.

Experiments have shown that introducing the microcapsules of the scented substance does not significantly alter the characteristics of the fabric produced, inasmuch as elongation and resistance to breakage is concerned, transversally or longitudinally.

Tests have been carried out whereby a base mixture is introduced, at 0.2%, 0.5%, 1%, 2.5% and 5%. The nonwoven fabric, with a basic weight of 40 g/mg, demonstrated lengthening and resistance to breakage in a transverse as well as longitudinal sense, which was completely consistent with respect to similar nonwoven fabric to which the base mixture had not been added.

Accordingly, the tests of tensile strength and elongation of the nonwoven fabric when the microcapsules of scented substances are added do not significantly vary from tests on the material without these microcapsules. Thus, it can be said that adding the base mixture does not significantly alter the characteristics of the resultant product.

On the basis of the above, it can thus be seen how the present invention achieves the proposed goals, in particular based on the fact that, using the process described above, a nonwoven fabric web can be obtained with scent characteristics that are particularly suitable for applications in various fields, especially the manufacture of absorbent diapers, diapers for the incontinent, curtains, household products and similar items.

The invention herein described can be modified and varied in many ways, all of which respect the concept of the invention.

Furthermore, the components as detailed can be replaced by others that are technically equivalent.

In practice, any materials can be employed, provided they are compatible with the specific use, as well as the contingent dimensions and forms, in accordance with requirements.

What is claimed is:

1. A process for manufacturing a nonwoven fabric of synthetic fiber with scented matter, said process comprising the steps of:
producing a molten mass of thermoplastic resin;
introducing into said molten mass a base mixture containing microcapsules of a scented substance;
extruding said molten mass into filaments;
drawing said extruded filaments; and
producing a web of said nonwoven fabric by means of said extruded filaments.

2. The process of claim 1, wherein said base mixture has been stirred into a compound using said thermoplastic resin for extrusion and said microcapsules of a scented substance at a percentage ranging from 10% to 70% by weight.

3. The process of claim 1, wherein said scented substance has a high boiling point.

4. The process of claim 1, wherein said base mixture is introduced at a percentage ranging from 0.2% to 5% by weight in respect to the total weight of said molten mass.

5. The process of claim 1, wherein said scented substance is in the form of microcapsules with a size less than one micron.

6. The process of claim 1, wherein said thermoplastic resins are extruded at a temperature ranging from 230° C. to 270° C.

7. The process of claim 1 wherein said thermoplastic resin is made of polypropylene.

8. The process of claim 1, wherein said thermoplastic resin is made of polyester.

9. The process of claim 1, wherein said thermoplastic resin is made of polyethylene.

10. The process of claim 1, wherein said extruded filaments are of a diameter greater than 0.5 dtex.

11. The process of claim 1, wherein said extruded filaments are spread in an overlapping pattern over a conveyor belt to obtain said nonwoven fabric web by means of compression between hot rollers, with temperature of the compression ranging from 120° C. to 180° C.
